(19) United States
(12) Patent Application Publication
(10) Pub. No.: US 2007/0271930 A1
(43) Pub. Date: Nov. 29, 2007

(54) Gas turbine having cooling-air transfer system

(75) Inventors: Yoshimasa Takaoka, Takasago-shi (JP); Masato Araki, Takasago-shi (JP); Vincent Laurello, Miami, FL (US); Masahito Kataoka, Takasago-shi (JP); Junichiro Masada, Takasago-shi (JP); Koichi Ishizaka, Takasago-shi (JP); Naoki Hagi, Takasago-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/416,454

(22) Filed: May 3, 2006

(51) Int. Cl. F02C 7/12

(52) U.S. Cl. 60/806

(57) ABSTRACT

A gas turbine includes a cooling-air transfer system. The cooing-air transfer system extracts part of air discharged from a compressor to a chamber, and transfers the part of air as cooling air to a rotor disk. The cooling-air transfer system includes a plurality of tubular nozzles independently arranged in a circle inside the chamber to surround a rotor, and a seal disk having seal-disk cooling conduits arranged in a circle around the axis of the rotor so as to receive cooling air ejected from the tubular nozzles. The cooling-air transfer system swirls the cooling air ejected from the tubular nozzles.

### BACKGROUND OF THE INVENTION

1. Field of the Invention

The present invention relates to a gas turbine having a cooling-air transfer system for air that cools moving blades.

2. Description of the Related Art

FIG. 10 is a conceptual view showing the general configuration of a gas turbine, and FIG. 11 is a structural view of a cooling-air transfer system and its surroundings in a known type of gas turbine.

In a gas turbine, air compressed by a compressor 51 is fed into a combustor 52, combustion gas is produced by combustion after mixing fuel in the compressed air, and is fed into a turbine 53 to rotate the turbine 53, and power is obtained from a power generator 54 by the rotation of the turbine 53, as shown in FIG. 10. Since the temperature of the produced combustion gas is high, it is necessary to cool moving blades and stationary blades. For that purpose, commonly, part of cooling air is extracted from a chamber that is provided on a discharging side of the compressor 51 to store air, and is supplied to the moving blades via a cooling-air transfer system.

An example of a cooling-air transfer system using cooling air for moving blades and stationary blades in the gas turbine will be described with reference to FIG. 11. Referring to FIG. 11, first-stage moving blades 33 are arranged in a circle around a first-stage rotor disk 34 that is coaxial with the compressor 51. The first-stage moving blades 33 receive the pressure of combustion gas F2 from the compressor 51, and rotate the first-stage rotor disk 34. Similarly, first-stage stationary blades 32 are arranged in a circle near a chamber 42 so as to be coaxial with the first-stage rotor disk 34. The first-stage stationary blades 32, the first-stage moving blades 33, and the first-stage rotor disk 34 constitute a first stage unit 31. A second-stage unit and a third-stage unit (not shown) are also coaxially connected to the downstream side of the first stage unit 31. Upstream from the first stage unit 31, a cooling-air transfer system is provided to feed cooling air Fl for the moving blades from the adjacent chamber 42 into the first-stage rotor disk 34.

The cooling-air transfer system includes TOBI (Tangential Onboard Injection) nozzles 45 and a seal disk 46. The seal disk 46 is coaxially connected to the first-stage rotor disk 34, and corotates therewith. The seal disk 46 includes seal-disk cooling conduits 47 that are formed of through holes and that are equally spaced in a circle around the axis of a rotor 41. The seal-disk cooling conduits 47 serve to guide cooling air F1 extracted from the chamber 42 to the first stage unit 31. The seal-disk cooling conduits 47 are arranged so that a circle obtained by connecting their centers forms a pitch circle centered on the axis of the rotor 41.

Air discharged from the compressor 51 is stored in the chamber 42, and part of cooling air F1 extracted from the chamber 42 is temporarily fed into a bleeding chamber 43. The bleeding chamber 43 is an annular space surrounded by the rotor 41 and a partition 48, and serves to uniformly supply the cooling air F1 to the cooling-air transfer system. The cooling air F1 fed from the chamber 42 into the cooling-air transfer system via the bleeding chamber 43. The cooling-air is supplied to the first-stage rotor disk 34 and to the first-stage moving blades 33 via a cooling-air inlet 44, the TOBI nozzles 45 and the seal-disk cooling conduits 47 provided in the seal disk 46. The cooling air F1 is also supplied to the second stage unit and the third stage unit (not shown) provided downstream from the first stage unit 31 in order to cool moving blades in the units.

While the bleeding chamber 43 and the TOBI nozzles 45 are stationary, the seal disk 46 and the first-stage rotor disk 34 corotate around the axis of the rotor 41. In general, when cooling air F1 ejected from the stationary TOBI nozzles 45 is introduced into the seal-disk cooling conduits 47 of the rotating seal disk 46, energy loss occurs. That is, the cooling air F1 has a velocity component in the circumferential direction of the seal disk 46 while flowing through each seal-disk cooling conduit 47, but does not have such a circumferential velocity component immediately before being supplied from the bleeding chamber 43 into the seal-disk cooling conduit 47. Therefore, in a case in which there is a velocity difference between the cooling air F1 and the seal disk 46 when the cooling air F1 is transferred into the seal-disk cooling conduit 47, a given energy loss (called pumping loss) is caused during the transfer. The pumping loss is mainly converted into heat. That is, when a great pumping loss is caused, the temperature of the cooling air F1 increases when the cooling air F1 is introduced into the seal-disk cooling conduit 47 of the seal disk 46, and this weakens the effect of cooling the moving blades. In contrast, when the pumping loss is small, the temperature rise can be limited, the cooling effect for the moving blades is improved, and the total efficiency of the gas turbine is enhanced. Therefore, it is important to minimize the pumping loss. For that purpose, there is a need to give a velocity component in the circumferential direction of the seal disk 46 to the cooling air F1 when the cooing air F1 is fed into the seal-disk cooling conduit 47. The TOBI nozzles 45 serve to give a circumferential velocity component to the cooling air F1 to swirl the cooling air F1, thereby reducing pumping loss.

The TOBI nozzles 45 conventionally constitute a nozzle ring having multiple bladed nozzles therein. The TOBI nozzle 45 swirls cooling air by discharging the cooling air in the rotating direction of the seal disk 46 in order to reduce pumping loss and to enhance the total efficiency of the gas turbine. Japanese Unexamined Patent Application Publication Nos. 2004-100686 and 2004-003494 disclose examples of cooling-air transfer systems using known blade-type TOBI nozzles. An example of a nozzle ring having blade-type TOBI nozzles is disclosed in FIG. 2 of Japanese Unexamined Patent Application Publication No. 2004-003494.

Japanese Unexamined Patent Application Publication No. 2004-003493 discloses tube-type TOBI nozzles that supply cooling air to a thrust balance disk in an axial-flow compressor.

However, the blade-type TOBI nozzles have a complicated structure, and the manufacturing cost thereof is high. Further, there is a limitation to the installation of the blade-type TOBI nozzles because the TOBI nozzles are installed in the bleeding chamber 43 serving as a narrow annular space provided inside the chamber 42 and surrounded by the partition 48 and the rotor 41. On the other hand, the tube-type TOBI nozzles disclosed in Japanese Unexamined Patent Application Publication No. 2004-003493 cannot form an effective swirling flow, and pumping loss is increased.

### SUMMARY OF THE INVENTION

In order to overcome the above-described problems, the present invention provides a gas turbine equipped with a compact and low-cost cooling-air transfer system having a simple structure.

A gas turbine according to an aspect of the present invention includes a cooing-air transfer system that extracts part of air discharged from a compressor to a chamber and that transfers the part of air as cooling air to a rotor disk. The cooling-air transfer system includes a plurality of tubular nozzles independently arranged in a circle inside the chamber to surround a rotor and to eject the cooling air, and a seal disk having seal-disk cooling conduits arranged in a circle around an axis of the rotor so as to receive the cooling air ejected from the tubular nozzles. Each of the tubular nozzles is disposed such that an axis of the tubular nozzle constantly crosses an axis of the rotor at an inclination angle in a rotating direction of the seal disk.

In this case, since TOBI nozzles having a simpler structure than blade-type TOBI nozzles can be adopted, the cost of the system is reduced. Moreover, since the cooling air can be easily swirled, pumping loss is reduced and the efficiency of the gas turbine is enhanced.

Preferably, an intersection of the axis of the tubular nozzle and a surface of the seal disk opposing the tubular nozzle is provided on a pitch circle of the seal-disk cooling conduits, the pitch circle being provided on the seal disk so as to be centered on the axis of the rotor, and the distance between an exit end of the tubular nozzle and the intersection is determined so as not to damp a jet flow of the cooling air.

In this case, since the jet flow of the cooling air ejected from the tubular nozzle is not damped, pumping loss is reduced.

Preferably, the bore of the tubular nozzle is determined by the pressure and temperature of the cooling air. The pressure of the cooling air is determined by a pressure loss caused in the tubular nozzle and a cooling-air transfer loss that is determined by a relative velocity difference between a circumferential velocity component of the cooling air and a circumferential velocity of the seal disk. The temperature of the cooling air is determined by a cooling-air temperature change determined by a temperature decrease corresponding to the expansion ratio of the cooling air in the tubular nozzle and by a cooling-air temperature change corresponding to the relative velocity difference.

In this case, since the optimal nozzle bore can be selected, the total efficiency of the gas turbine is enhanced.

Preferably, the distance between the exit end of the tubular nozzle and the intersection is less than or equal to ten times the bore of the tubular nozzle.

In this case, the cooling air flow reaches the seal-disk cooling conduit without decreasing the center velocity thereof. Therefore, the cooling air flow can be smoothly transferred in the seal-disk cooling conduit, and this reduces pumping loss.

Preferably, the tubular nozzle includes a nozzle body and a nozzle tip that are detachable.

In this case, since the nozzle body and the nozzle tip can be easily attached and detached, easy maintenance is possible.

### BRIEF DESCRIPTION OF THE DRAWINGS

FIG. 1 is a structural view of a gas turbine incorporating a cooling-air transfer system according to a first embodiment of the present invention.

FIG. 2 is a cross-sectional view taken along line II-II in FIG. 1, showing an arrangement example of tubular nozzles in the first embodiment.

FIG. 3 is a front view of a seal disk in the first embodiment.

FIG. 4A is a perspective view of the cooling-air transfer system, showing the three-dimensional relationship among components, FIG. 4B is a cross-sectional view taken along line IVB-IVB in FIG. 4A, and FIG. 4C is a cross-sectional view taken along line IVC-IVC in FIG. 4B.

FIG. 5A is an explanatory view showing the relationship between a circumferential velocity component of cooling air and the circumferential velocity of the seal disk, FIG. 5B is a graph showing the relationship between the temperature change of the cooling air and the relative velocity difference (Vt-Ut) caused by transfer, and FIG. 5C is a graph showing the relationship between the cooling-air transfer loss and the relative velocity difference (Vt-Ut).

FIG. 6 is a graph showing the relationship between the velocity ratio of the cooling air (V/Vm) and the ratio L/D.

FIGS. 7A and 7B are structural views of the tubular nozzles in the first embodiment.

FIG. 8 is a graph showing the changes in pressure of the cooling air.

FIG. 9 is a flowchart showing the procedure for calculating the pressures of the cooling air.

FIG. 10 is a conceptual view showing the general configuration of a gas turbine.

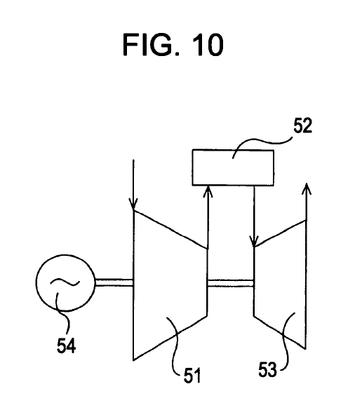

FIG. 11 is a structural view of a cooling-air transfer system and its surroundings in a known-type of gas turbine.

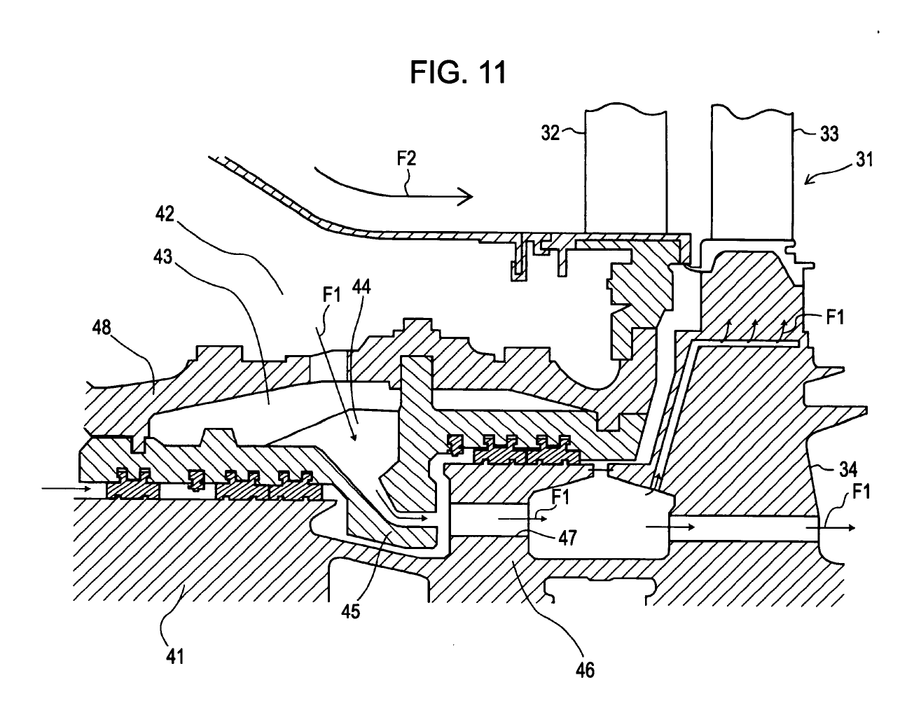

### DESCRIPTION OF THE PREFERRED EMBODIMENTS

While an embodiment of the present invention will be described with reference to the drawings, it is to be understood that the embodiment is just exemplary and does not limit the scope of the invention. Components similar to those in the related arts are denoted by the same reference numerals, and detailed descriptions thereof are omitted.

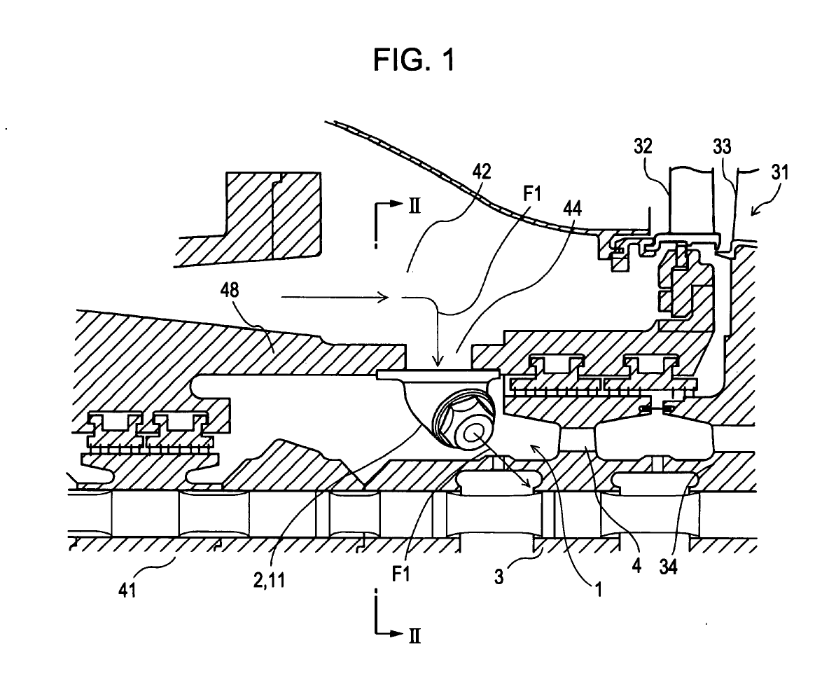

First, a gas turbine including a cooling-air transfer system according to the present invention will be described below. The concept of a gas turbine including a compressor, a combustor, and a turbine has been given in the description of the background of the invention, and therefore, a description thereof is omitted. Referring to FIG. 1, a cooling-air transfer system 1 serving as the core of the invention includes a group 2 of a plurality of tubular nozzles 11 provided on an inner surface of a partition 48 inside a chamber 42 that stores air discharged from the compressor, and a seal disk 3 provided downstream from and adjacently to the tubular nozzle group 2 and having seal-disk cooling conduits 4. The tubular nozzle group 2 serves to extract part of air from the chamber 42 and to supply cooling air F1 to the seal-disk cooling conduits 4 of the seal disk 3. The tubular nozzles 11 in the group 2 are mounted on the partition 48 provided inside the chamber 42, and are separately arranged in a circle around a rotor 41, thus constituting a tube-type TOBI nozzle unit.

The seal-disk cooling conduits 4 are provided near the outer periphery of the seal disk 3 adjacent to the tubular nozzle group 2 so as to extend through the seal disk 3 and parallel to a rotor axis 41a, and are equally spaced in a circle. The seal-disk cooling conduits 4 receive cooling air F1 ejected from the tubular nozzles 11, and supply the cooling air F1 to a first rotor disk 34 provided downstream therefrom. The cooling air F1 cools moving blades before it is finally ejected from cooling holes provided at the tips of the moving blades into combustion gas.

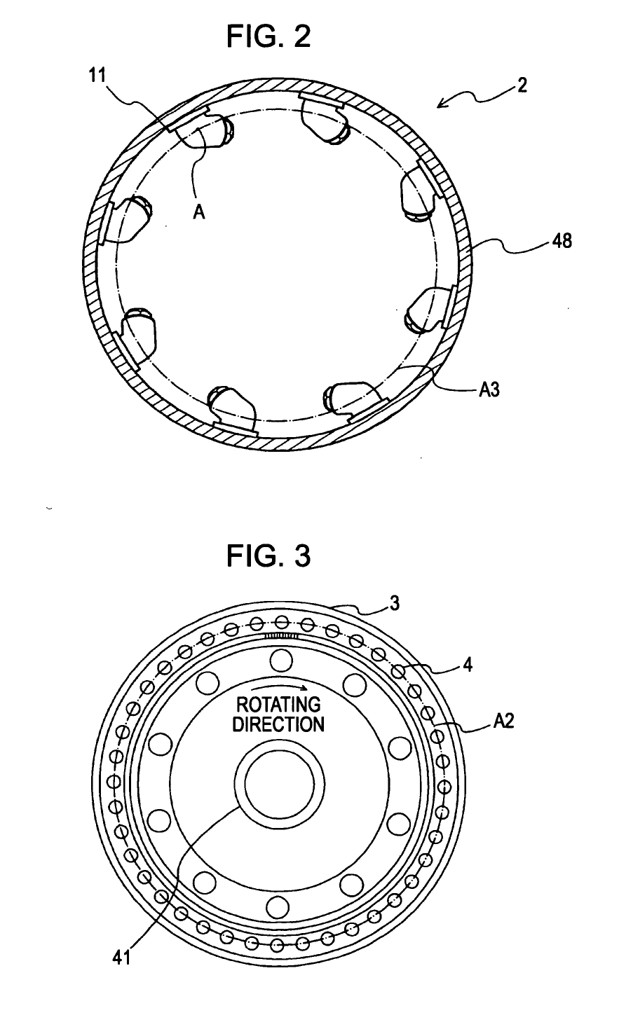

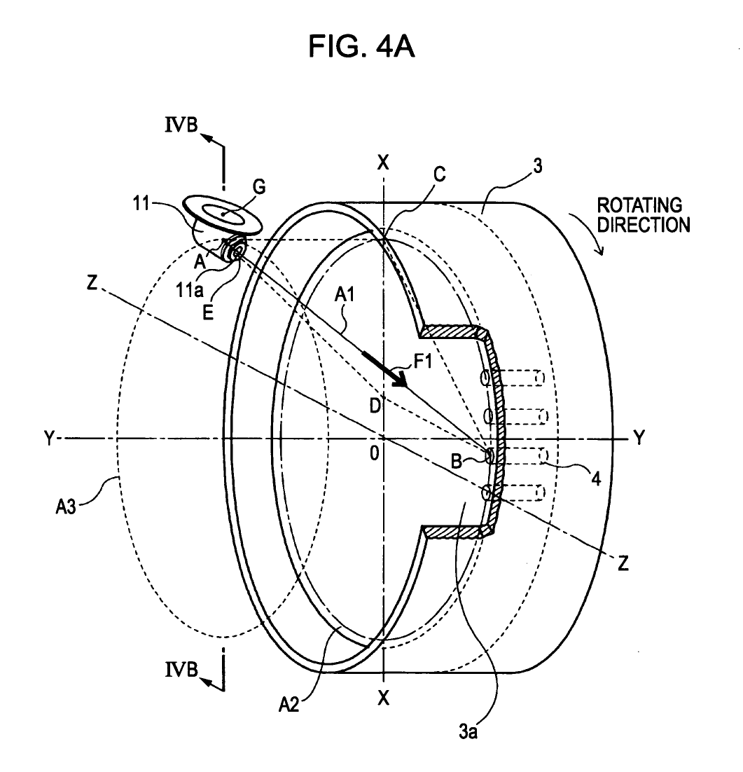

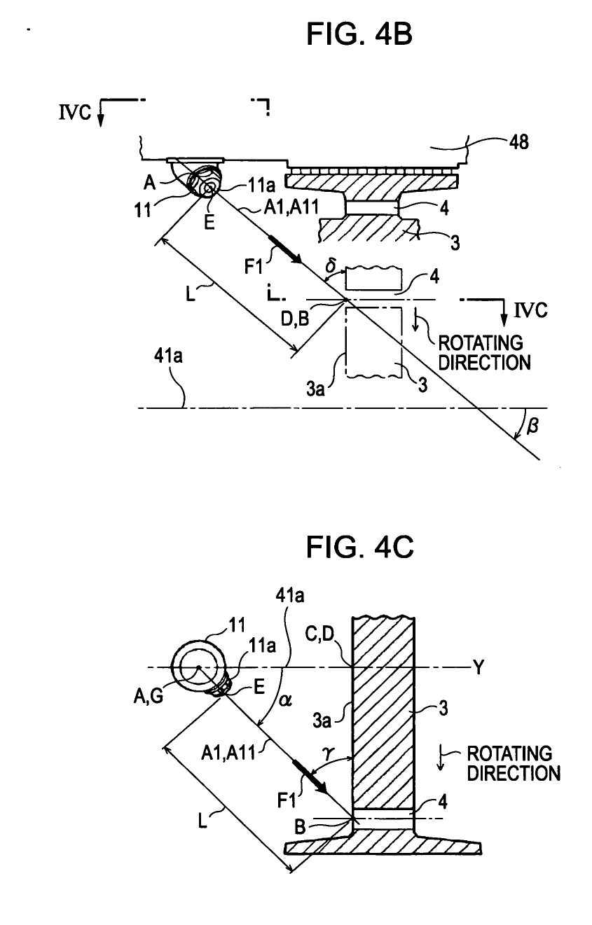

FIG. 2 shows an example in which the tubular nozzle group 2 includes eight tubular nozzles 11 (a cross-section taken along line II-II in FIG. 1). In order to uniformly supply cooling air to the seal-disk cooling conduits 4 of the seal disk 3, it is preferable that a number of tubular nozzles 11 ranging from four to thirty two be equally spaced in a circle around the rotor axis 41a. When the number of the tubular nozzles 11 is three or less, it is difficult to uniformly distribute the cooling air. In contrast, when the number of the tubular nozzles 11 exceeds thirty two, it is difficult to ensure a sufficient mounting space, and this increases the cost. In FIG. 2, a circle A3 represents a nozzle-body center pitch circle formed by connecting the center points (points A in FIG. 4A) of nozzle bodies 12 that define the tubular nozzles 11. That is, a plurality of tubular nozzles 11 are separately arranged in a circle on the nozzle-body center pitch circle A3. FIG. 3 is a front view of an example of a seal disk 3 (a cross-sectional view taken along line II-II in FIG. 1). A seal-disk cooling-conduit pitch circle A2 is formed by connecting the center points of the seal-disk cooling conduits 4.

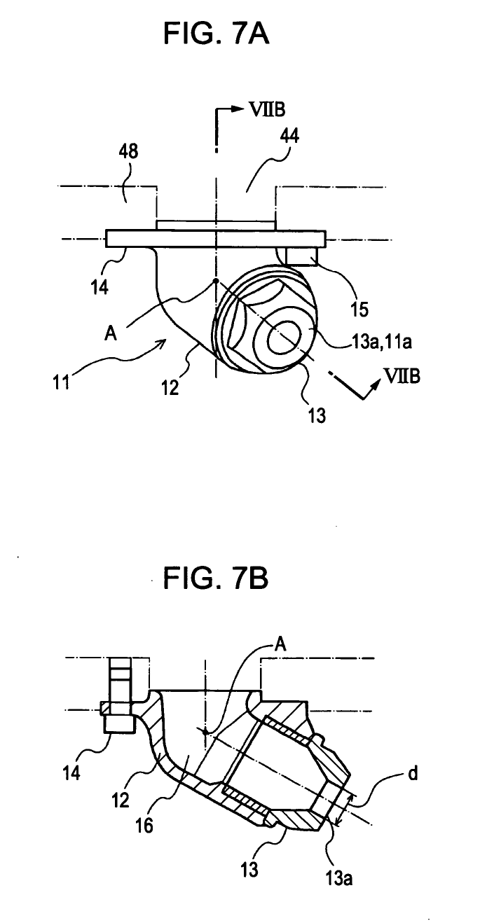

FIG. 4A three-dimensionally shows the positional relationship between the tubular nozzles 11 and the seal-disk cooling conduits 4. The seal disk 3 corotates with the rotor 41 (FIGS. 1 and 3). While a plurality of tubular nozzles 11 are arranged on the nozzle-body center pitch circle A3, only one tubular nozzle 11 is shown in FIG. 4A for simple explanation. FIGS. 4B and 4C are a side view (a cross-sectional view taken along line IVB-IVB in FIG. 4A) and a plan view (a cross-sectional view taken along line IVC-IVC in FIG. 4B), respectively, showing the relationship between the tubular nozzle 11 and the seal-disk cooling conduit 4. In FIG. 4A, a point O represents a rotor center point on a seal-disk rotating surface 3a of the seal disk 3, an X-axis represents an axis passing through the point O so as to be perpendicular to the rotor axis 41a, a Y-axis represents a horizontal axis that coincides with the rotor axis 41a, and a Z-axis represents a horizontal axis passing through the point O so as to be orthogonal to the Y-axis. Further, a point A represents the center point of the nozzle body 12 of the tubular nozzle 11 (FIGS. 7A and 7B), a point B represents an intersection of a tubular-nozzle axis A1 (a line extending from the axial center at an exit of the tubular nozzle 11) with the seal-disk cooling-conduit pitch circle A2, a point C represents an intersection of a perpendicular dropped parallel to the Y-axis from the point A, with the X-axis, and a point D represents an intersection of a perpendicular dropped parallel to the Z-axis from the point B, with the X-axis.

The tubular nozzle 11 mounted on the partition 48 is stationary. On the other hand, the adjacent seal disk 3 and the downstream first rotor disk 34 corotate with the rotor 41. Therefore, in order for cooling air F1 to smoothly flow from the tubular nozzle 11 into the seal-disk cooling conduit 4, it is necessary to swirl the cooling air F1. In the blade-type TOBI nozzle that has been given in the description of the background art, multiple blades are arranged in a circle inside a nozzle ring, and cooling air is swirled in the circumferential direction inside the nozzle ring by the blades so as to be supplied into the adjacent seal-disk cooling conduits. However, the tube-type TOBI nozzle does not have such a complicated blade structure.

When the tube-type TOBI nozzle disclosed in Japanese Unexamined Patent Application Publication No. 2004-003493 is used, the direction in which cooling air is ejected from the tubular nozzle (tubular-nozzle axis) is parallel to the rotor axis. That is, cooling air is ejected along a plane that includes the point A, that is parallel to the rotor axis 41a, and that is perpendicular to a plane including the rotor axis 41a and the point A (hereinafter referred to as a nozzle blowing plane). When the tubular-nozzle axis A1 formed by the cooling air ejected along this plane is projected on the nozzle blowing plane, it is constantly parallel to the rotor axis 41a on the nozzle blowing plane as a projection plane. In a case in which the tubular nozzle is positioned as in Japanese Unexamined Patent Application Publication No. 2004-003493, the inclination angle between the tubular-nozzle axis A1 and the rotor axis 41a (angle α in FIG. 4C) needs to be large to some extent in order to obtain a swirling flow. However, when the inclination angle is too large, the direction of cooling air ejected from the tubular nozzle 11 deviates outward from the seal-disk cooling-conduit pitch circle A2. Although the inclination angle can be increased to some extent by lowering the mounting position of the tubular nozzle 11 toward the rotor axis 41a in order to avoid the outward deviation, since there is no sufficient space between the tubular nozzle 11 and the outer surface of the rotor 41, the space in which the mounting position is lowered is limited, and the inclination angle is also limited. Therefore, it is impossible to obtain an effective swirling flow in this method.

In contrast, in the tube-type TOBI nozzle according to the present invention, in order to swirl cooling air F1, the tubular nozzle 11 is disposed at a distance from the seal disk 3 so that the tubular-nozzle axis A1 is inclined at a predetermined angle with respect to the rotor axis 41a in the rotating direction of the seal disk 3. More specifically, the tubular nozzle 11 needs to be placed so that, when the tubular-nozzle axis A1 is projected on the nozzle blowing plane, a tubular-nozzle axis on the projection plane (referred to as a projected tubular-nozzle axis A11) constantly crosses the rotor axis 41a on the same projection plane at a predetermined angle in the rotating direction of the seal disk 3. In FIG. 4A, the rotating direction of the seal disk 3 means the clockwise direction when the seal disk surface 3a is viewed from the side of the tubular nozzle 11. FIGS. 4B and 4C show a case in which the tubular-nozzle axis A1 is projected on a plane parallel to the rotor axis 41a and orthogonal to the nozzle blowing plane. In FIGS. 4B and 4C, the tubular-nozzle axis A1 corresponds to the projected tubular-nozzle axis A11.

A structure for producing a swirling flow will be specifically described with reference to FIGS. 4B and 4C. The tubular nozzle 11 is disposed upstream from the adjacent seal disk 3 and at a predetermined distance from the rotating surface 3a of the seal disk 3. Cooling air F1 is ejected from the tubular nozzle 11 toward the seal-disk cooling-conduit pitch circle A2 on the seal disk 3 along the tubular-nozzle axis A1 (projected tubular-nozzle axis A11). That is, the mounting angle of the tubular nozzle 11 is determined so that the tubular-nozzle axis A1 (projected tubular-nozzle axis A11) is inclined from the rotor axis 41a at a predetermined angle in the rotating direction of the seal disk 3. Consequently, the tubular-nozzle axis A1 crosses the seal-disk rotating surface 3a at a point B on the seal-disk cooling-conduit pitch circle A2. That is, the mounting angle is represented by the angle β (pitch angle) formed between the tubular-nozzle axis A1 (projected tubular-nozzle axis A11) and the rotor axis 41a in FIG. 4B, and by the angle α (swirl angle) formed between the tubular-nozzle axis A1 (projected tubular-nozzle axis A11) and the rotor axis 41a in FIG. 4C. The mounting angle of the tubular nozzle 11 is determined so that each of the angle α (swirl angle) and the angle β (pitch angle) forms a predetermined angle with respect to the rotor axis 41a. When the tubular nozzle 11 is placed, as in Japanese Unexamined Patent Application Publication No. 2004-003493, the pitch angle β in FIG. 4B is 0, and the tubular-nozzle axis A1 (projected tubular-nozzle axis A11) is parallel to the rotor axis 41a.

When the angle formed between the tubular-nozzle axis A1 (projected tubular-nozzle axis A11) and the seal-disk rotating surface 3a is designated as δ and γ, respectively, in FIGS. 4B and 4C, cooling air F1 ejected from the tubular nozzle 11 can be more smoothly swirled by mounting the tubular nozzle 11 so that the angles α and β are large and the angles δ and γ are small. However, since the tubular nozzle 11 is disposed directly above the outer surface of the rotor 41, the mounting space thereof is limited. Therefore, if the mounting angle is too large, the tubular-nozzle axis A1 interferes with the rotor 41, and this disturbs the cooling air F1 ejected from the tubular nozzle 11. In normal cases, the angle α is set to be within the range of 45° to 90°, more preferably, of 50° to 80°, and the angle β is set to be within the range of 0° to 45°, more preferably, of 10° to 40°. By thus setting the mounting angle, a velocity component in the rotor circumferential direction can be given to the cooling air F1 ejected from the tubular nozzle 11. As a result, the cooling air F1 is effectively swirled, and can be easily transferred into the seal-disk cooling conduit 4. This reduces pressure loss resulting from the transfer.

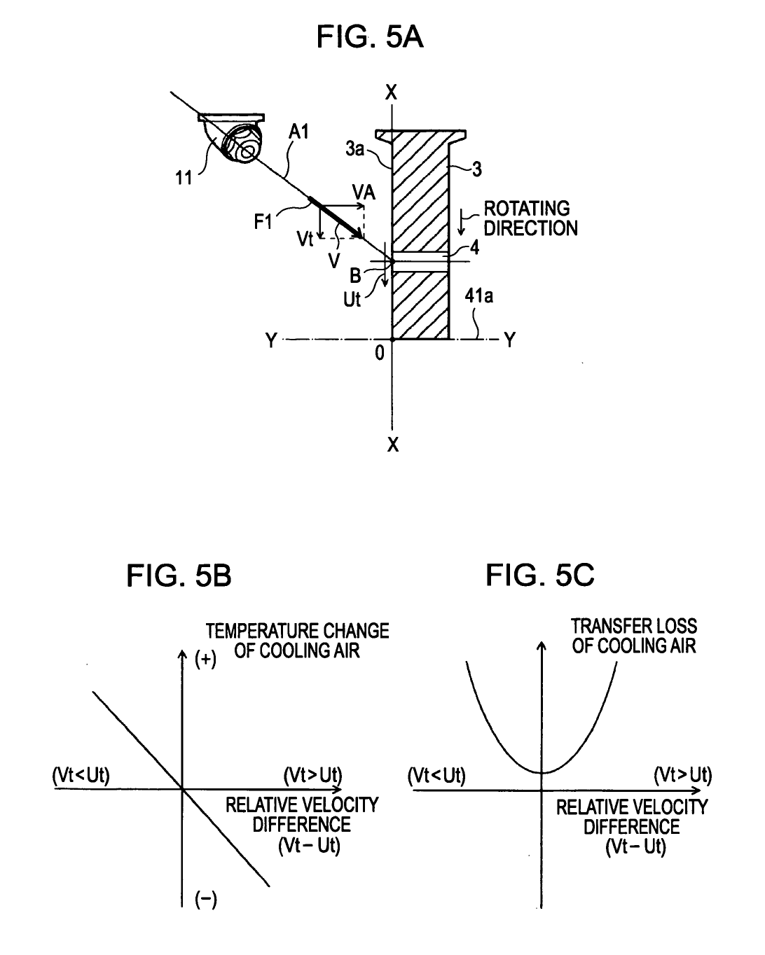

With reference to FIGS. 5A to 5C, a specific description will be given of the relationship among the relative velocity difference between the cooling air F1 and the seal disk 3, the pressure loss, and the cooling-air temperature change provided when the cooling air F1 is transferred in the seal-disk cooling conduit 4. As shown in FIG. 5A, cooling air F1 ejected from the tubular nozzle 11 flows along the tubular-nozzle axis A1, and reaches the point B on the seal-disk rotating surface 3a. The cooling air F1 reaches the point B at a flow velocity (V) in the direction of the tubular-nozzle axis A1 and with a circumferential velocity component (Vt) and an axial velocity component (VA). When the circumferential velocity of the seal disk 3 at the point B is designated as Ut, it is preferable that the relative velocity difference (Vt-Ut) between the circumferential velocity Ut and the circumferential velocity component Vt of the cooling air F1 be small in order for the cooling air F1 to be smoothly transferred into the seal-disk cooling conduit 4.

In a graph of FIG. 5B, the horizontal axis indicates the relative velocity difference (Vt-Ut), and the vertical axis indicates the temperature change of the cooling air depending on the relative velocity difference (Vt-Ut). This graph is obtained experimentally. When the relative velocity difference (Vt-Ut) is 0, the temperature of the cooling air is not changed by the transfer. As the relative velocity difference increases to the positive side, the temperature change of the cooling air increases to the negative side. That is, the temperature of the cooling air relatively decreases after the transfer. In contrast, when the relative velocity difference (Vt-Ut) increases to the negative side, the temperature change of the cooling air increases to the positive side, conversely to the above, and the temperature of the cooling air rises after the transfer.

In FIG. 5B, when the vertical axis indicates the pumping loss, instead of the above-described temperature change of the cooling air, the relationship between the pumping loss and the relative velocity difference (Vt-Ut) can be read. That is, when the relative velocity difference (Vt-Ut) increases to the positive side, the pumping loss increases to the negative side, and the efficiency of the turbine rises. In contrast, when the relative velocity difference (Vt-Ut) increases to the negative side, the pumping loss increases to the positive side, and the efficiency of the turbine falls.

In FIG. 5C, the horizontal axis indicates the relative velocity difference (Vt-Ut), and the vertical axis indicates the cooling-air transfer loss depending on the relative velocity difference (Vt-Ut). The cooling-air transfer loss is caused by pressure loss due to the relative velocity difference (Vt-Ut) and pressure loss due to, for example, a contracted flow produced when the cooling air flows into the seal-disk cooling conduit 4. The cooling-air transfer loss is experimentally calculated. As shown in FIG. 5C, the cooling-air transfer loss is the minimum when the relative velocity difference (Vt-Ut) is 0, and increases both when the relative velocity difference increases to the positive side and to the negative side.

The positional relationship between the tubular nozzle 11 and the seal-disk cooling conduit 4 will now be described from the viewpoint of damping of cooling air F1 ejected from the tubular nozzle 11.

In general, a cooling-air jet flow ejected from an exit end 11a of the tubular nozzle 11 tends to be damped and the flow velocity thereof tends to decrease, depending on the distance from the exit end 11a. Therefore, it is preferable to place the tubular nozzle 11 and the seal-disk cooling conduit 4 within a distance such that the jet flow is hardly damped. When the distance between the tubular-nozzle exit end 11a and the point B in FIG. 4A is too long, a cooling-air jet flow from the tubular nozzle 11 is greatly damped before reaching the point B, and the flow velocity V of the cooling air F1 in the direction of the tubular-nozzle axis A1 decreases. When the flow velocity V decreases, the relative velocity difference decreases, or deviates to the negative side. In particular, when the relative velocity difference deviates to the negative side, there are adverse influences from the viewpoints of the temperature change and transfer loss of cooling air, and the pumping loss. However, even when the relative velocity difference deviates to the negative side, the efficiency of the gas turbine can be effectively enhanced than the conventional gas turbines in which it is difficult to place a blade-type TOBI nozzle.

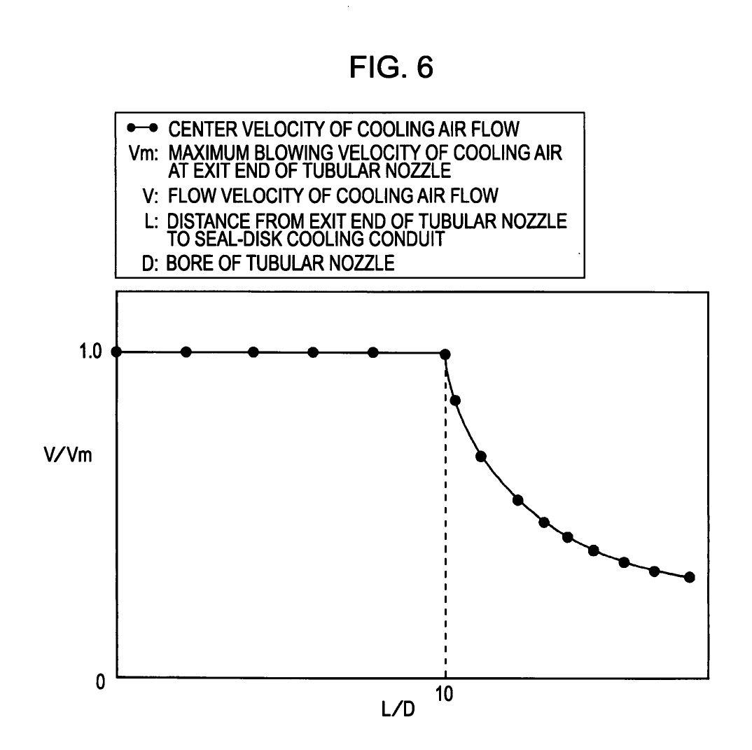

FIG. 6 shows the degree of damping of a cooling-air jet flow depending on the distance from the tubular-nozzle exit end 11a. In FIG. 6, the horizontal axis indicates the ratio (L/D) of the distance L between the tubular-nozzle exit end 11a and the point B, and the bore D of the tubular nozzle 11, and the vertical axis indicates the ratio (V/Vm) of the maximum blowing velocity (Vm) of the cooling-air jet flow and the cooling-air flow velocity (V). The maximum cooling-air blowing velocity (Vm) refers to the flow velocity of cooling air F1 immediately after the cooling air F1 is ejected from the tubular-nozzle exit end 11a. As shown in FIG. 6, when the rate L/D is 10 or less, the center velocity of the cooling air F1 hardly decreases. In contrast, when the rate L/D exceeds 10, the center velocity remarkably decreases. That is, when the rate L/D is 10 or less, the decrease in damping rate of the jet flow of the cooling air F1 does not cause a problem. In contrast, when the rate L/D exceeds 10, the decrease in damping rate of the jet flow has an adverse effect. When it is assumed that the jet flow of the cooling air F1 is not damped in a range such that the center velocity of the cooling air F1 does not decrease, it is preferable to determine the distance L from the tubular-nozzle exit end 11a to be less than or equal to ten times the nozzle bore D, in which the jet flow is not damped. This relationship between the length L and the bore D will be described with reference to FIG. 4A. When the center point of the tubular-nozzle exit end 11a is designated as E in FIG. 4A, the length between the two points B and E on the tubular-nozzle axis A1 corresponds to the above-described distance L. By setting the length L between the points B and E to be ten times the nozzle bore D, damping of the jet flow of the cooling air F1 can be reduced.

The structure of the tubular nozzle 11 will now be described. As shown in FIGS. 7A and 7B, the tubular nozzle 11 includes a nozzle body 12, a nozzle tip 13, a nozzle flange 14, and a mounting bolt 15. The tubular nozzle 11 is fixed to the partition 48 by mounting the nozzle flange 14 on an inner surface of the partition 48 by the mounting bolt 15. Bolt fixing allows nozzles to be independently attached and detached, and it is unnecessary to replace all the nozzles together, unlike the seal ring of the bladed seal disk. Therefore, easy maintenance is possible. The nozzle body 12 is formed of one bent piece because it needs to receive cooling air F1 from a cooling-air inlet 44 provided in the partition 48, and to immediately turn the direction of the cooling air F1 toward the seal-disk rotating surface 3a. For this reason, a smaller bend radius and a more compact nozzle structure can be achieved than in a tubular nozzle formed by a typical bent pipe. When the cooling air Fl is introduced from the chamber 42 into the tubular nozzle 11, it is rapidly contracted, and therefore, the flow of the cooling air F1 is easily disturbed. In order to minimize the disturbance, an air reservoir 16 is provided inside the nozzle body 12. The air flow remains in the air reservoir 16 for some time, and this absorbs disturbance of the air flow. The nozzle tip 13 is fastened to the nozzle body 12 by a screw structure. With this structure, when the nozzle tip 13 is damaged or when the nozzle tip 13 is replaced with a nozzle tip having different specifications because of the change of the operating condition, replacement can be performed easily. Further, the inner diameter of the nozzle tip 13 gradually decreases from the air reservoir 16 toward a nozzle-tip exit end 13a, and the nozzle tip 13 has a circular cross section including linear portions near the exit end 13a. In this case, an effect of rectifying the air inside the tubular nozzle 11 can be expected, and the air flow is rarely disturbed at the tubular-nozzle exit end 11a. The above-described nozzle bore D corresponds to the inner diameter d of an aperture at the nozzle-tip exit end 13a.

A description will be given below of the change in pressure of cooling air from an entrance of the tubular nozzle to the tip of a moving blade in the cooling-air transfer system 1 of the present invention. Referring to FIG. 1, the pressure of combustion gas at an entrance of a stationary blade (first-stage stationary blade 32) and the pressure at the entrance of the tubular nozzle 11 (pressure at the cooling-air inlet 44) are slightly lower than or equal to the chamber air pressure, and it may be thought that the chamber air pressure, the pressure of combustion gas at the entrance of the stationary blade, and the pressure at the entrance of the tubular nozzle are substantially equal. A combustion gas section in which cooling air is ejected from the tip of the moving blade is, for example, a region in which combustion gas passing through the first-stage stationary blade 32 flows. The pressure P5 of the combustion gas at the first moving blade falls below the chamber pressure (tubular-nozzle entrance pressure P1) because of pressure loss through the passage. In order for moving-blade cooling air passing through the cooling-air transfer system 1 to effectively cool the moving blade and to be ejected into the combustion gas while ensuring the required amount thereof, the moving-blade tip pressure P4 needs to be constantly higher than the moving-blade combustion-gas-section pressure P5. When the moving blade tip pressure P4 is lower than the moving-blade combustion-gas-section pressure P5, the high-temperature combustion gas flows back into the moving blade, and this may damage the moving blade. While a first-stage unit 31 has been described as an example above, this also applies to a second-stage unit and a third-stage unit (both not shown) provided downstream from the first-stage unit 31.

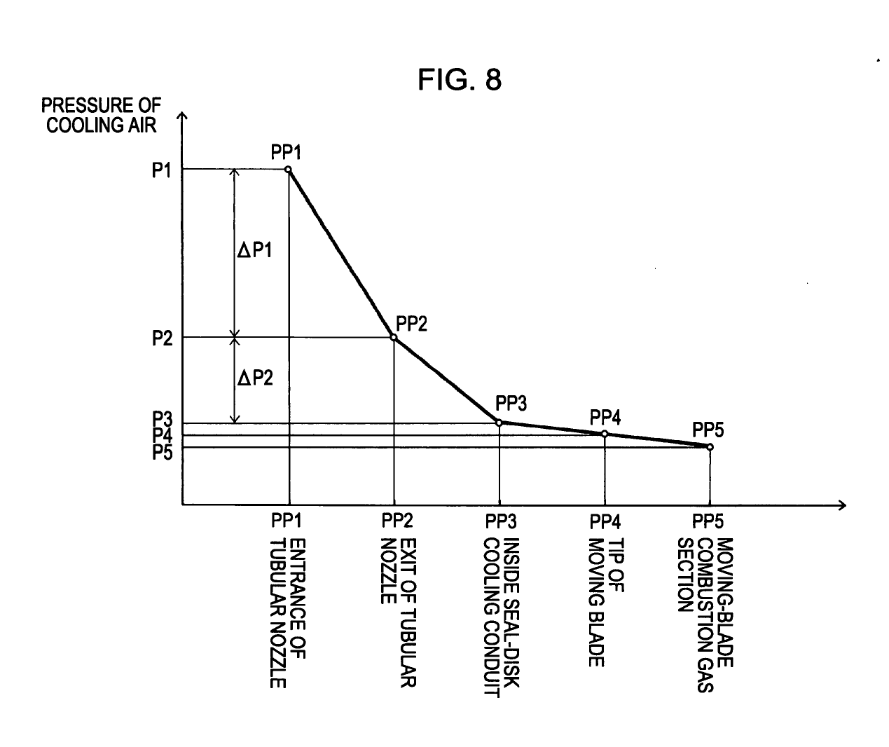

FIG. 8 specifically shows the passing points of cooling air in the moving-blade cooling-air system and the pressure changes of the cooling air. In FIG. 8, PP1 to PP5 on the horizontal axis represent the passing points of the cooling air between the entrance of the tubular nozzle 11 and the moving-blade combustion gas section. More specifically, PP1 represents the entrance of the tubular nozzle 11, PP2 represents the exit of the tubular nozzle 11, PP3 represents the inside of the seal-disk cooling conduit 4, PP4 represents the tip of the moving blade, and PP5 represents the moving-blade combustion gas section. The vertical axis indicates the pressure of the cooling air. P1 to P5 on the vertical axis represent the pressures at the passing points PP1 to PP5, respectively.

The pressure changes are inspected under the conditions that the required amount of cooling air applied to the moving blade is determined, and that the arrangement of the tubular nozzles 11 (i.e., the number of nozzles), and the distance L between each tubular-nozzle exit end 11a (point E) and the point B on the seal-disk cooling-conduit pitch circle A2, that is, the relative positions of the tubular nozzle 11 and the seal-disk cooling conduit 4 are determined. By determining the nozzle bore D under these conditions, the pressure changes from the passing point PP1 to the passing point PP4 can be calculated. That is, it is possible to think that the pressure loss is substantially constant while cooling air F1 transferred to the seal-disk cooling conduit 4 flows downstream through the seal-disk cooling-conduit inside PP3 and then reaches the moving-blade tip PP4, unless the amount of the cooling air is changed. In contrast, even when the amount of the cooling air is fixed, the pressure loss varies depending on the nozzle bore D of the used tubular nozzle while the cooing air F1 passes through the tubular-nozzle entrance PP1 and the tubular-nozzle exit PP2, and reaches the seal-disk cooling-conduit inside PP3.

More specifically, the tubular-nozzle exit pressure P2 and the nozzle expansion ratio (the ratio of the tubular-nozzle entrance pressure P1 and the tubular-nozzle exit pressure P2) are determined by the nozzle bore D. In addition, the pressure loss in the tubular nozzle 11 is determined. Cooling air F1 expanded in the tubular nozzle 11 is ejected from the tubular-nozzle exit end 11a, reaches the point B on the seal-disk cooling-conduit pitch circle A2, and then flows in the seal-disk cooling-conduit inside PP3. In this case, it is determined, according to FIG. 6, whether the ratio L/D is 10 or less, in order to avoid the influence of damping of the jet flow of the cooling air. When the cooling air F1 flows in the seal-disk cooling-conduit inside PP3, a cooling-air transfer loss is caused. The cooling-air transfer loss includes pressure loss due to the relative velocity difference (Vt-Ut) between the circumferential velocity Ut of the seal disk 3 and the circumferential velocity component Vt of the cooling air F1 and pressure loss due to, for example, contraction at the entrance of the seal-disk cooling conduit 4. When it is assumed that the pressure loss in the tubular nozzle 11 is designated as ΔP1 and the cooling-air transfer loss is designated as ΔP2, P2=P1−ΔP1 and P3=P2−ΔP2. Consequently, the pressure P3 in the seal-disk cooling-conduit inside PP3 and the moving-blade tip pressure P4 are determined. When the difference between the moving-blade tip pressure P4 and the moving-blade combustion-gas-section pressure P5 exceeds an allowed value (α1), the moving-blade cooling air is constantly ejected into the combustion gas, and normal cooling for the moving blades is ensured.

The temperature T1 of cooling air F1 fed into the tubular nozzle 11 is substantially equal to the chamber air temperature. When the expansion ratio at the tubular nozzle 11 is determined, a temperature decrease ΔT1 at the tubular-nozzle exit end 11a can be calculated on the basis of expansion caused by decompression of the cooling air inside the tubular nozzle 11, and the cooling-air temperature T2 at the tubular-nozzle exit end 11a can be determined. That is, T2=T1−ΔT1. Further, when the cooling air F1 is transferred from the tubular nozzle 11 into the seal-disk cooling conduit 4, a cooling-air temperature change ΔT2 is made depending on the relative velocity difference (Vt-Ut), as shown in FIG. 5B. Therefore, the temperature T3 of the cooling air F1 that flows into the moving blade via the seal-disk cooling conduit 4 is expressed as T1−ΔT1+ΔT2. In order to effectively cool the moving blade, it is necessary to keep the cooling-air temperature T3 lower than or equal to a temperature that is lower by a predetermined value (α2) than the temperature of combustion gas in the moving-blade combustion-gas section.

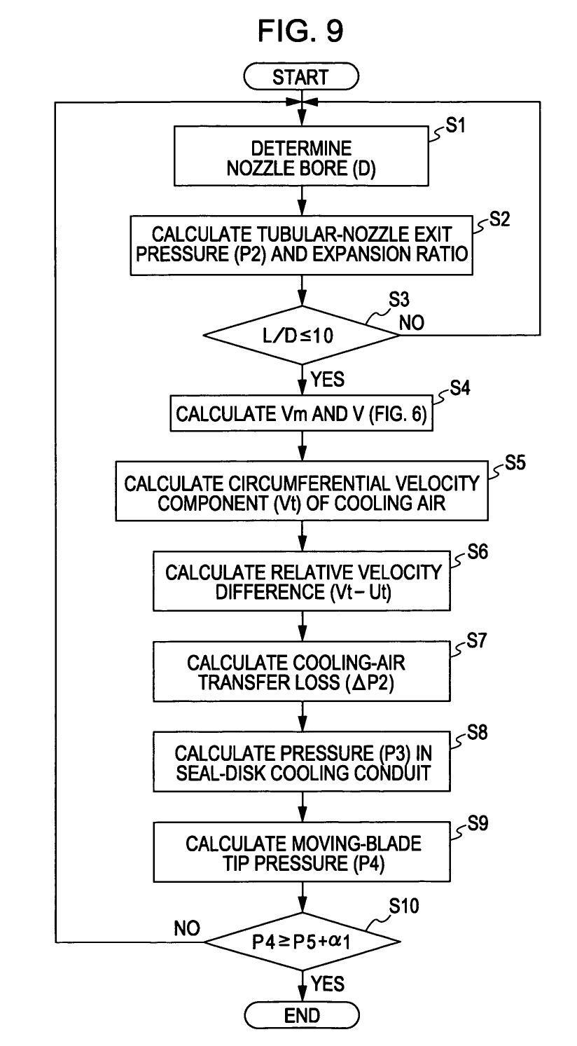

A procedure for calculating the pressures of the cooling air at the passing points PP1 to PP5 will be described in detail with reference to FIG. 9.

First, the nozzle bore D of the tubular nozzle 11 is determined (Step S1), and the tubular-nozzle exit pressure P2 and the nozzle expansion ratio are calculated (Step S2). Then, as described above, it is determined with reference to FIG. 6 whether the ratio L/D is 10 or less, from the viewpoint of damping of the jet flow of the cooling air (Step S3). When the ratio L/D is higher than 10, it is determined that damping of the cooling-air jet flow is excessive, and Step S1 is performed again to set the nozzle bore D. When the ratio L/D is 10 or less, it is determined that the cooling-air jet flow is not damped, and the maximum cooling-air blowing velocity Vm at the tubular-nozzle exit end 11a and the flow velocity V of the cooling air F1 corresponding to the predetermined ratio L/D are calculated (Step S4). The circumferential velocity component Vt of the seal-disk 3 is obtained from the above values Vm and V (Step S5). Subsequently, the relative velocity difference (Vt-Ut) is calculated (Step S6), and the cooling-air transfer loss ΔP2 corresponding to the relative velocity difference (Vt-Ut) is obtained according to FIG. 5C (Step S7). When the cooling-air transfer loss ΔP2 is determined, the seal-disk cooling-conduit inside pressure P3 and the moving-blade tip pressure P4 of the cooling air F1 transferred in the seal-disk cooling conduit 4 are calculated (Steps S8 and S9). Then, the moving-blade tip pressure P4 and the moving-blade combustion-gas-section pressure P5 are compared to determine whether the condition P4≧P5+α1 is satisfied (Step S10). When P4<P5+α1, the combustion gas flows back into the moving blade, and therefore, Step S1 is performed again to set the nozzle bore D. When P4≧P5+α1, the moving-blade tip pressure P4 is higher than the moving-blade combustion-gas-section pressure P5, and the combustion gas will not flow back. In this case, it is determined that the set nozzle bore D is proper, and that the pressures P1 to P4 of the cooling air flow at the passing points PP1 to PP4 are proper.

When the pressure changes of the cooling air flow are properly determined, as described above, the temperature decrease ΔT1 in the tubular nozzle, the cooling-air temperature T2 at the tubular-nozzle exit, and the cooling-air temperature T3 at the moving-blade entrance are calculated on the basis of the expansion ratio in the tubular nozzle, and it is determined whether the difference between the moving-blade combustion-gas temperature T4 and the cooling-air temperature T3 in the moving blade is more than or equal to the predetermined value (α2).

Through the above-described procedure, the specifications of the cooling-air transfer system can be optimized. This can enhance the total efficiency of the gas turbine.

What is claimed is:

1. A gas turbine comprising a cooing-air transfer system that extracts part of air discharged from a compressor to a chamber and that transfers the part of air as cooling air to a rotor disk,
wherein the cooling-air transfer system includes:
a plurality of tubular nozzles independently arranged in a circle inside the chamber to surround a rotor and to eject the cooling air; and
a seal disk having seal-disk cooling conduits arranged in a circle around an axis of the rotor so as to receive the cooling air ejected from the tubular nozzles, and
wherein each of the tubular nozzles is disposed such that an axis of the tubular nozzle constantly crosses an axis of the rotor at an inclination angle in a rotating direction of the seal disk.

2. The gas turbine according to claim 1, wherein an intersection of the axis of the tubular nozzle and a surface of the seal disk opposing the tubular nozzle is provided on a pitch circle of the seal-disk cooling conduits, the pitch circle being provided on the seal disk so as to be centered on the axis of the rotor, and the distance between an exit end of the tubular nozzle and the intersection is determined so as not to damp a jet flow of the cooling air.

3. The gas turbine according to claim 1 or 2, wherein the bore of the tubular nozzle is determined by the pressure and temperature of the cooling air,
wherein the pressure of the cooling air is determined by a cooling-air transfer loss that is determined by a pressure loss caused in the tubular nozzle and a relative velocity difference between a circumferential velocity component of the cooling air and a circumferential velocity of the seal disk, and
wherein the temperature of the cooling air is determined by a cooling-air temperature change determined by a temperature decrease corresponding to the expansion ratio of the cooling air in the tubular nozzle and the relative velocity difference.

4. The gas turbine according to claim 3, wherein the distance between the exit end of the tubular nozzle and the intersection is less than or equal to ten times the bore of the tubular nozzle.

5. The gas turbine according to claim 1 or 2, wherein the tubular nozzle includes a nozzle body and a nozzle tip that are detachable.
